(19) United States
(12) Patent Application Publication
(10) Pub. No.: US 2006/0098557 A1
(43) Pub. Date: May 11, 2006

(54) Optical detection system and method to detect storage areas of an optical storage medium

(75) Inventor: Yung-Yu Lin, Hsin-Chu City (TW)

Correspondence Address: TROXELL LAW OFFICE PLLC, Suite 1404, 5205 Leesburg Pike, Falls Church, VA, 22041, US

(73) Assignee: MediaTek Inc.

(21) Appl. No.: 11/319,174

(22) Filed: Dec. 28, 2005

Related U.S. Application Data
(62) Division of application No. 10/390,630, filed on Mar. 19, 2003.

(30) Foreign Application Priority Data
Sep. 23, 2002 (TW) 091121791

(51) Int. Cl. G11B 7/00

(52) U.S. Cl. 369/124.13

(57) ABSTRACT

The present invention is an optical detection system to detect various areas of an optical storage medium. The optical detection system comprises a pickup head, a signal adder and an adding comparator. The pickup head have a light source for providing an incident light beam to the data area and the header, and generating the corresponding reflective light beam. The pickup head detects the reflective light beam to generate left-side detection signals and right-side detection signals. The signal adder adds the amplitudes of the left-side detection signal and the right-side detection signal to generate an adding signal. The adding comparator compares the adding signal with a predetermined adding reference signal to generate a compared adding signal. According to the compared adding signal, the optical detection system can determine that the reflective light beam detected by the pickup head comes from the data area or the header.

### BACKGROUND OF THE INVENTION

1. Field of the Invention

The present invention relates to an optical detection system to detect various areas of an optical storage medium.

2. Description of the Prior Art

Please refer to FIG. 1. FIG. 1 is a schematic diagram of the structure of the storage area of an optical storage medium. A known rewritable digital video optical disk (DVD-RAM) has two kinds of storage tracks 13 to record data. One is the land storage track, and the other is the groove storage track. Both of them can store data, and be divided into a central region 15 and two edge regions 16. Each section of integrated data can be set as a sector 10. Each sector 10 further comprises a header 11 and a data area 12. The header 11 is used for storing address data. The data area 12 is used for storing video data. The data in the header 11 and the data area 12 are written on the storage track 13 with pits 14. The location arrangement of the pits 14 on the header 11 and the data area 12 are different. On the data area 12, the pits 14 for storing video data are arranged in the central region 15 of the storage track 13, but on the header 11, the pits 14 for storing address data are arranged in the edge regions 16 of the storage track 13. Moreover, the arrangement of the pits 14 for storing the address data on the land storage track differs from the arrangement on the groove storage track. The arrangement of the pits 14 for storing the address data on the land storage track and on the groove storage land is just inverted.

The pickup head locks on the center of the storage track 13. The light source emitted from the pickup head can be divided into four parts. The known optical detection system detects the reflective light beam from the optical storage medium to generate detection signals. The optical detection system adds the signals reflected from the optical storage medium in the left side of the pickup head to generate a set of detection signals, and adds the signals reflected from the optical storage medium in the right side of the pickup head to generate the other set of detection signals. While the pickup head is reading in the data area 12, the difference of the two sets of the detection signals is zero. While the pickup head is reading in the header 11, the difference of the two sets of the detection signals is not zero. Thus the optical detection system can recognize that the pickup head is disposing in header 11 or data area 12.

The optical detection system in the prior art detects the reflective light beam from the optical storage medium to generate detection signals via calculation. The detection signals are calculated by the above-mentioned process. Then the two sets of the detection signals are inputted into a low pass filter to filter off the noise so as to generate a low pass filtered signal. The low pass filtered signal is compared with a predetermined reference signals in the high threshold comparator and the low threshold comparator to generate a high threshold compared signal and a low threshold compared signal. While both of the high threshold compared signal and the low threshold compared signal are not zero, the pickup head is disposing in the header. Detect if the not-zero high threshold compared signal is generated before than the low threshold compared signal, so it can tell that the pickup head is disposing in the land storage track or the groove storage track.

According to the optical detection system in the prior art, the pickup head must locks on the center of the storage track 13. However, the pickup head is easily vibratory, especially when the pickup head is moving from the header 11 to the data area 12. Due to the vibration happened on the pickup head, it may introduce a deviation between the pickup head and the storage tracks 13 and cause the pickup head unlocked on the center of the storage track. Therefore the high threshold compared signal and the low threshold compared signal are not correct anymore, and the pickup head reproduces wrong signals from the optical disk.

Consequently, there is a need to improve optical detection system, which is not influenced by the pickup head locked on the center of the track. The present invention is to provide an improved optical detection system to solve the problem mentioned above.

### SUMMARY OF THE INVENTION

The objective of this invention is to provide an optical detection system and method to detect storage areas of an optical storage medium to prevent error reproducing since the pickup head doesn't lock on the 6enter of the storage track.

The present invention relates to an optical detection system. The optical detection system further comprises a first detection system and a second detection system to detect the various storage areas of an optical storage medium. There is a plurality of sectors set in the direction of the storage track on the optical storage medium. Each sector can be divided into a central region and two edge regions. Each sector comprises a data area and a header. The data area is used for storing a digital data. The header is used for storing an address data. The digital data is stored in the central region of the data area. The address data is stored in the edge regions of the header.

The first detection system of the optical detection system comprises a pickup head, a signal adder and an adding comparator. The pickup head includes a light source for providing an incident light beam to the data area and the header, and the light beam is modulated by a plurality of bits to generate a corresponding reflective light beam. The pickup head is set in a predetermined distance away from the optical storage medium for substantially locking on the central region of the sector, and detecting a reflective light beam along the direction of the storage track. The pickup head comprises a left-side detection module and a right-side detection module. The left-side detection module is set in the left side of the pickup head along the direction of the storage track for detecting the reflective light beam to generate a set of left-side detection signals correspondingly. The right-side detection module is set in the right side of the pickup head along the direction of the storage track for detecting the reflective light beam to generate a set of right-side detection signals correspondingly. The signal adder adds the amplitudes of the left-side detection signal and the right-side detection signal detected by the pickup head to generate a corresponding adding signal. The adding comparator compares the adding signal with a predetermined adding reference signal to generate a compared adding signal.

According to the compared adding signal, the optical detection system can determine where the reflective light beam detected by the pickup head comes from the data area or the header.

The second detection system of the optical detection system comprises a pickup head, a signal subtractor and a band pass filter. The pickup head includes a light source for providing an incident light beam to the data area and the header, and the light beam is modulated by the plurality of bits to generate a corresponding reflective light beam. The pickup head is set in a predetermined distance away from the optical storage medium for substantially locking on the central region of the sector, and detecting a reflective light beam along the direction of the storage track. The pickup head comprises a left-side detection module and a right-side detection module. The left-side detection module is set in the left side of the pickup head along the direction of the storage track for detecting the reflective light beam to generate a set of left-side detection signals correspondingly. The right-side detection module is set in the right side of the pickup head along the direction of the storage track for detecting the reflective light beam to generate a set of right-side detection signals correspondingly. The signal subtractor gets the difference between the set of the left-side detection signals and the set of the right-side detection signals detected by the pickup head by means of a predetermined signal subtraction procedure to generate a corresponding subtraction signal. The band pass filter filters off the high frequency and the low frequency of the subtraction signal to generate a band pass filtered signal.

According to the band pass filtered signal, the optical detection system can determine where the reflective light beam detected by the, pickup head comes from the land storage track or the groove storage track.

To sum up the above-mentioned illustration, the present invention uses two detection systems to detect the data area, the header, the land storage track and the groove storage track on the optical storage medium respectively. The optical detection system not only can detect different storage areas but also prevent error reproducing since the pickup head doesn't lock on the center of the storage track 13.

These and other objects, advantages and features of the present invention will become more apparent from the following detailed description thereof taken in conjunction with the accompanying drawings which illustrate specific embodiments of the invention.

### BRIEF DESCRIPTION OF THE APPENDED DRAWINGS

FIG. 1 is a schematic diagram of the structure of the storage area of an optical storage medium.

FIG. 2 is a schematic diagram of the first detection system and the second detection system according to the present invention.

FIG. 3 is a waveform diagram of the compared signals generated by the first detection system and the second detection system based on FIG. 2.

FIG. 4 is a low chart of the First detection system according to the present invention.

FIG. 5 is a flow chart of the second detection system according to the present invention.

### DETAILED DESCRIPTION OF THE INVENTION

The objective of the present invention is to provide an optical detection system to detect various storage areas of an optical storage medium. The optical storage medium comprises at least one land storage track and at least one groove storage track. Each storage track 13 can be divided into a central region 15 and two edge regions 16. The optical storage medium can be a rewritable digital versatile disk (DVD-RAM).

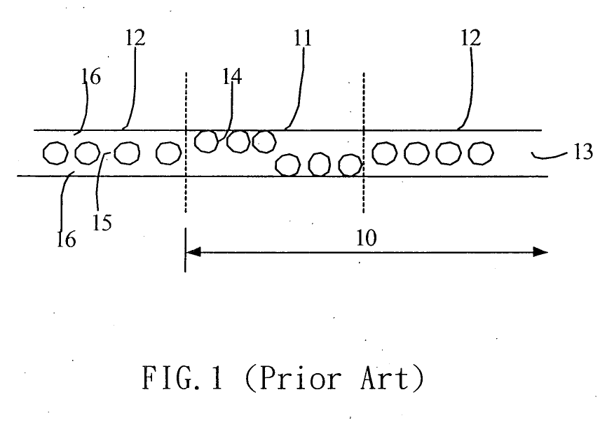

As the storage track 13 shows in FIG. 1, the storage track 13 can be divided into a central region 15 and two edge regions 16. There is a plurality of sectors 10 set in the direction of the storage track 13 on the optical storage medium. Each sector 10 can be divided into a central region 15 and two edge regions 16. Each sector 10 comprises a data area 12 for storing a digital video data and a header 11 for storing an address data. The digital data is stored in the central region 15 of the data area 12 in digital format. The address data including a plurality of bits is stored in the edge regions 16 of the header 11.

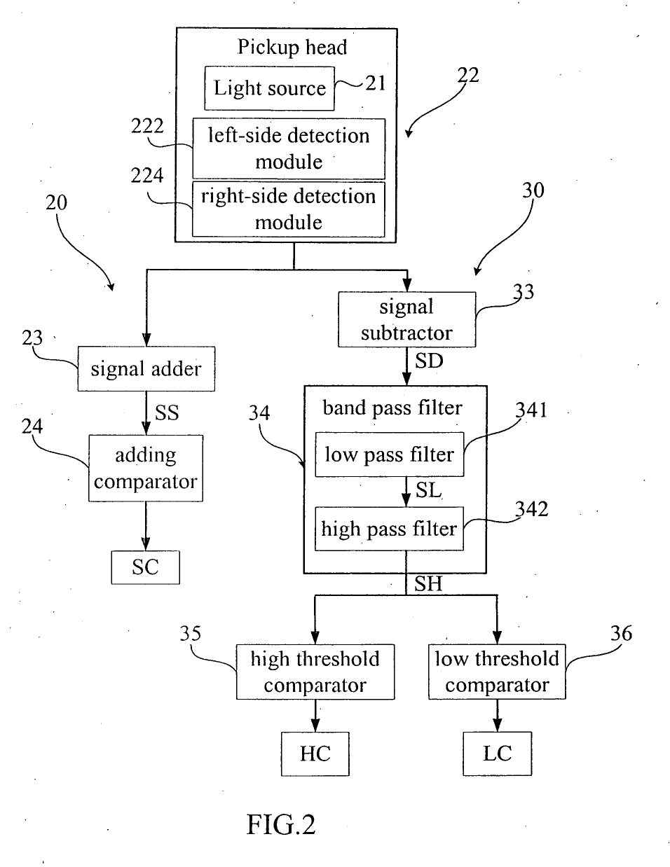

The optical detection system of the present invention further comprises a first detection system and a second detection system. Please refer to FIG. 2. FIG. 2 is a schematic diagram of the first detection system 20 and the second detection system 30 according to the present invention. The first detection system 20 comprises a pickup head 22, a signal adder 23 and an adding comparator 24. The pickup head 22 includes a light source 21 for providing an incident light beam to the data area 12 and the header 11, and the light beam is modulated by a plurality of bits to generate the corresponding reflective light beam. The pickup head 22 is set in a predetermined distance away from the optical storage medium for substantially locking on the central region 15 of the sector 10, and detecting a reflective light beam along the direction of the storage track 13.

The pickup head 22 comprises a left-side detection module 222 and a right-side detection module 224. The left-side detection module 222 is set in the left side of the pickup head 22 along the direction of tile storage track 13 for detecting the reflective light beam so as to generate a set of left-side detection signals correspondingly. The right-side detection module 224 is set in the right side of the pickup head 22 along the direction of the storage track 13 for detecting the reflective light beam so as to generate a set of right-side detection signals correspondingly.

The signal adder 23 adds the amplitudes of the set of left-side detection signals and the set of right-side detection signals detected by the pickup head 22 to generate an adding signal SS. The adding comparator 24 compares the adding signal SS with a predetermined adding reference signal to generate a compared adding signal SC.

According to the compared adding signal SC, the optical detection system can determine whether the reflective light beam detected by the pickup head 22 comes from the data area 12 or the header 11.

The left-side detection module 222 further comprises a first detector and a fourth detector (not show in FIG. 2). The first detector is set in the rear left side of the pickup head 2,2 along the direction of the sector 10 for detecting the reflective light beam received along the direction of the rear left side from the sector 10 so as to generate a corresponding first detection signal. The fourth detector is set in the front left side of the pickup head 22 along the direction of the sector 10 for detecting the reflective light beam received along the direction of the front left side from the sector 10 so as to generate a corresponding fourth detection signal.

The right-side detection module 224 as described above also comprises a second detector and a third detector (not show in FIG. 2). The second detector is set in the rear right side of the pickup head 22 along the direction of the sector 10 for detecting the reflective light beam received along the direction of the rear right side from the sector 10 so as to generate a corresponding second detection signal. The third detector is set in the front right side of the pickup head 22 along the direction of the sector 10 for detecting the reflective light beam received along the direction of the front right side from the sector 10 so as to generate a corresponding third detection signal. The signal adder 23 receives and adds the amplitudes of the first detection signal, the second detection signal, the third detection signal and the fourth detection signal together so as to generate the adding signal SS.

Also in FIG. 2, the second detection system 30 of the present invention detects various storage tracks 13 of an optical storage medium. The second detection system 30 of the optical detection system comprises a pickup head 22 including a light source 21, a signal subtractor 33, a band pass filter 34, a high threshold comparator 35 and a low threshold comparator 36. The light source 21 and the pickup head 22 in the second detection system 30 are the same as the light source 21 and the pickup head 22 in the first detection system 20 respectively. The signal subtractor 33 gets the difference between the set of the left-side detection signals and the set of the right-side detection signals detected by the pickup head 22 by a predetermined signal subtraction procedure so as to generate a subtraction signal SD. The predetermined signal subtraction procedure gets the difference between the amplitude sum of the first detection signal and the fourth detection signal and the amplitude sum of the second detection signal and the third detection signal so as to generate the subtraction signal SD. The band pass filter 34 filters off the high frequency and the low frequency of the subtraction signal SD so as to generate a band pass filtered signal SH. The high threshold comparator 35 compares the band pass filtered signal SH with a predetermined high threshold reference signal so as to generate a high threshold compared signal HC. The low threshold comparator 36 compares the band pass filtered signal SH with a predetermined low threshold reference signal so as to generate a low threshold compared signal LC. After comparing the second pulse of the band pass filtered signal SH, a high threshold compared signal HC or a low threshold compared signal LC will be generated. According to the comparing result that is the high threshold compared signal HC or the low threshold compared signal LC, the optical detection system can determine that the reflective light beam detected by pickup head 22 comes from the land storage track or the groove storage track. If the result is the low threshold compared signal LC, the reflective light beam detected by the pickup head 22 comes from the land storage track. If the result is the high threshold compared signal HC, the reflective light beam detected by pickup head 22 comes from the groove storage track.

The band pass filter 34 of the second detection system 30 further comprises a low pass filter 341 and a high pass filter 342. The low pass filter 341 filters off the high frequency of the subtraction signal SD so as to generate a low pass filtered signal SL. The high pass filter 342 filters off the low frequency of the low pass filtered signal SL so as to generate a band pass filtered signal SH. The low pass filtered signal SL is a kind of step signal, and the band pass filtered signal SH is a kind of pulse signal.

In another embodiment, the signal subtraction procedure gets the difference between the sum of phases of the second detection signal and the fourth detection signal, and the sum of phases of the first detection signal and the third detection signal to generate the subtraction signal SD. The second detection signal and the fourth detection signal are in-phase signals, and the first detection signal and the third detection signal are in-phase signals. The subtraction signal SD is a differential phase detection (DPD) signal.

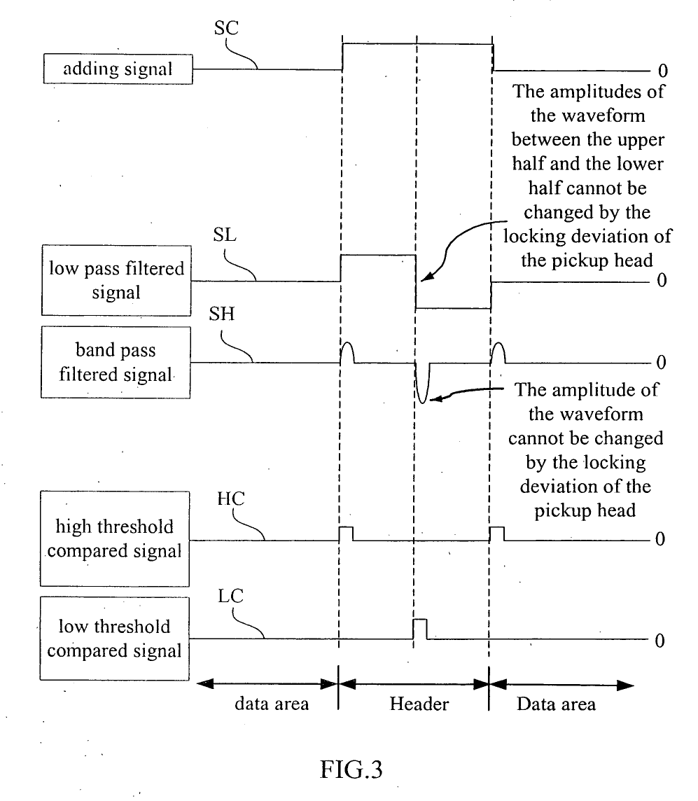

Please refer to FIG. 3. FIG. 3 is a waveform diagram of the compared signals generated by the first detection system 20 and the second detection system 30 based on FIG. 2. In FIG. 3, the compared adding signal SC generated by the first detection system 20 is a non-zero level waveform in the header 11. In other words, if the compared adding signal SC is not zero, the pickup head 22 is disposing in the header 11. If the compared adding signal SC is zero, the pickup head 22 is disposing in the data area 12. The low pass filtered signal SL generated by the low pass filter 341 show an up and down waveform in the header 11. The up and down waveform is a non-zero waveform. The amplitudes of the waveform between the upper half and the lower half cannot be changed by the locking deviation of the pickup head 22. Then the low pass filtered signal SL is filtered off the low frequency by the high pass filter 342 to generate a band pass filtered signal SH. The band pass filtered signal SH comprises three pulses, two of them located in the intersection of the header 11 and the data area 12, and the other one located in the intersection of the right pits and the left pits in the header 11. The three pulses of the band pass filtered signal SH are compared by the high threshold comparator 35 to generate the high threshold compared signal HC, and compared by the low threshold comparator 36 to generate the low threshold compared signal LC. If only the low threshold compared signal LC is generated, after the second pulse of the band pass filtered signal is compared, the optical head 22 is disposing in the land storage track. On the other hand, if only the high threshold compared signal HC is generated, after the second pulse of the band pass filtered signal is compared, the optical head 22 is disposing in the groove storage track.

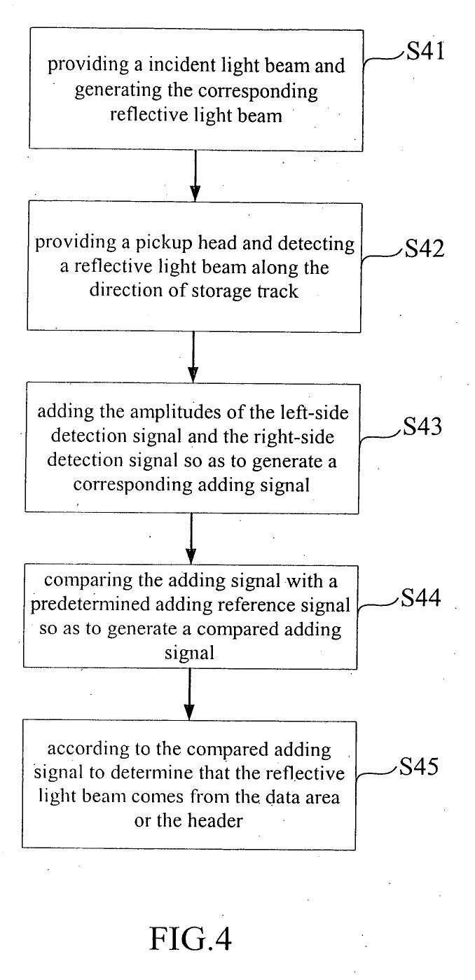

Please refer to FIG. 4. FIG. 4 is a flow chart of the first detection system 20 according to the present invention. The optical detection method of the first detection system 20 of the present invention is illustrated by the following steps:

S41: providing an incident light beam to the data area and the header, and the light beam is modulated by the plurality of bits to generate the corresponding reflective light beam;

S42: providing a pickup head and setting in a predetermined distance away from the optical storage medium, for substantially locking on the central region of the sector, and detecting a reflective light beam along the direction of storage track;

S43: adding tile amplitudes of the left-side detection signal and the right-side detection signal detected by the pickup head to generate a corresponding adding signal;

S44: comparing the adding signal with a predetermined adding reference signal to generate a compared adding signal; and

S45: according to the compared adding signal, the optical detection method can determine that the reflective light beam detected by the pickup head comes from the data area or the header.

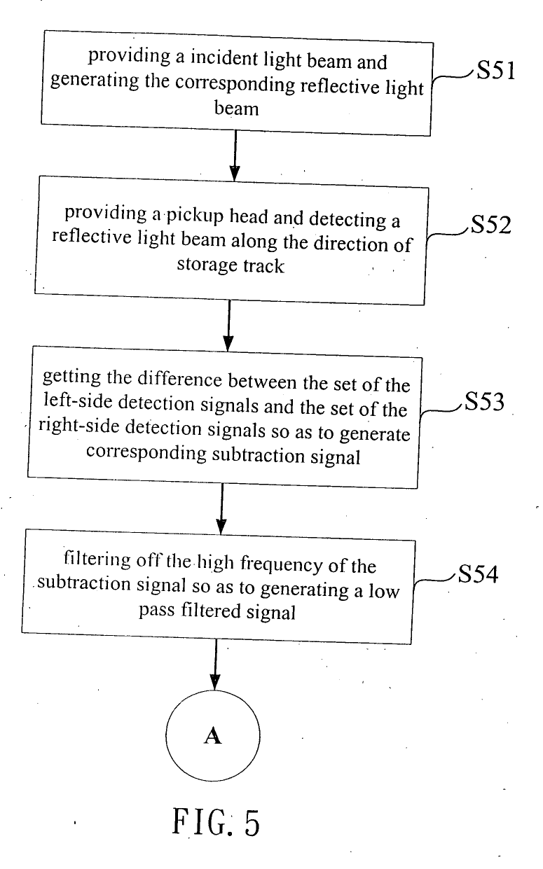

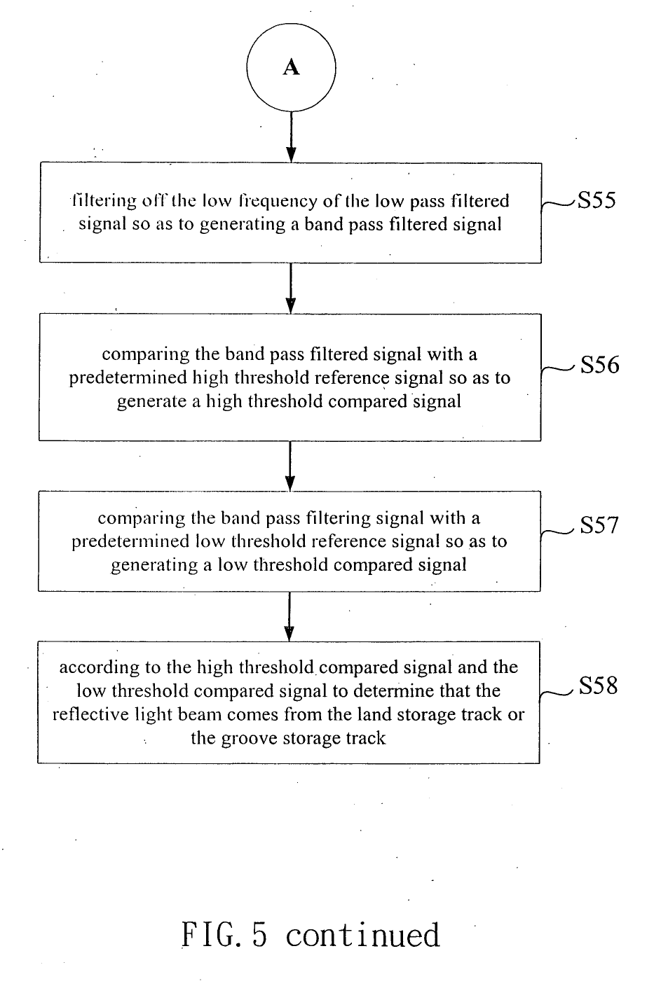

Please refer to FIG. 5. FIG. 5 is a flow chart of the second detection system 30 according to the present invention. The method of present invention comprises the following steps:

S51: providing an incident light beam to the data area and the header, and the light beam is modulated by a plurality of bits to generate a corresponding reflective light beam;

S52: providing a pickup head and setting in a predetermined distance away from the optical storage medium, for substantially locking on the central region of the sector, and detecting a reflective light beam along the direction of the storage track;

S53: getting the difference between the set of the left-side detection signals and the set of the right-side detection signals detected by the pickup head by a predetermined signal subtraction procedure to generate a corresponding subtraction signal;

S54: filtering off the high frequency of the subtraction signal to generate a low pass filtered signal;

S55: filtering off the low frequency of the low pass filtered signal to generate a band pass filtered signal;

S56: comparing the band pass filtered signal with a predetermined high threshold reference signal to generate a high threshold compared signal;

S57: comparing the band pass filtered signal with a predetermined low threshold reference signal to generate a low threshold compared signal; and

S58: according to the high threshold compared signal and the low threshold compared signal, the optical detection method determining that the reflective light beam detected by the pickup head comes from the land storage track or the groove storage track.

In the optical detection system of the prior art, the pickup head must precisely lock on the central region of the storage track. If there is any deviation between the pickup head and the storage track, the identification of the storage track or the sector will not be correct, and even influence the proceeding of the data reproducing. Thus the optical detection system of the present invention outstandingly improves this problem, and has the high utility. The optical detection system in the prior art has no solution to improve this problem and to identify the various areas of the sectors immediately. Therefore, the optical detection system of the present invention obviously has the novelty. The detection signals of the present invention uninfluenced by the deviation between the pickup head and the storage track, so the first detection system and the second detection system of the present invention can compare and identify the correct location of the pickup head. That shows the present invention is an innovative and advanced design. That the optical detection system of the present invention has the non-obviousness naturally is no doubt.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

1-4. (canceled)

5. An optical detection system for detecting various storage tracks of an optical storage medium, said optical storage medium comprising at least one land storage track and at least one groove storage track, each storage track being divided into a central region and two edge regions, and each sectors further comprising a data area to record a digital data and a header to record an address data, the digital data comprising a plurality of bits data and being stored in the central region of the data area along the direction of the storage track, the address data also comprising a plurality of bits data and being stored in the edge region of the header along the direction of the storage track, the data storage sequence of the address data stored in the edge region of the header being different from said land storage area and said groove storage area, said optical detection system comprising:
a pickup head for substantially locking on the central region of the sector, and detecting a reflective light beam along the direction of the storage track, said pickup head comprising:
a light source for providing an incident light beam to said data area and said header, and modulated by the plurality of bits to generate said corresponding reflective light beam;
a left-side detection module, disposed in the left side of said pickup head along the direction of said storage track, for detecting said reflective light beam to generate a set of left-side detection signals correspondingly; and
a right-side detection module, disposed in the right side of said pickup head along the direction of said storage track, for detecting said reflective light beam to generate a set of right-side detection signals correspondingly;
a signal subtractor for getting the difference between the left-side detection signals and the right-side detection signals detected by the pickup head by means of a predetermined signal subtraction procedure to generate a corresponding subtraction signal; and
a band pass filter for filtering off the high frequency and the low frequency of the subtraction signal to generate a band pass filtered signal;
wherein the optical detection system can determine that the reflective light beam detected by said pickup head comes from the land storage track or the groove storage track according to the band pass filtered signal.

6. The optical detection system of claim 5, wherein the predetermined signal subtraction procedure gets the difference between the amplitude of the left-side detection signal and the amplitude of the right-side detection signal detected by the pickup head to generate a corresponding subtraction signal .

7. The optical detection system of claim 5, wherein the left-side detection module further comprises:
a first detector, disposed in the rear left side of said pickup head along the direction of the sector, for detecting the reflective light beam received along the direction of the rear left side from the sector to generate a corresponding first detection signal; and
a fourth detector, disposed in the front left side of said pickup head along the direction of the sector, for detecting the reflective light beam received along the direction of the front left side from the sector to generate a corresponding fourth detection signal.

8. The optical detection system of claim 7, wherein the right-side detection module further comprises:
a second detector, disposed in the rear right side of said pickup head along the direction of the sector, for detecting the reflective light beam received along the direction of the rear right side from the sector, and generating a corresponding second detection signal; and
a third detector, disposed in the front right side of said pickup head along the direction of the sector, for detecting the reflective light beam received along the direction of the front right side from the sector, and generating a corresponding third detection signal.

9. The optical detection system of claim 8, wherein the predetermined signal subtraction procedure gets the difference between the amplitude sum of the first detection signal and the fourth detection signal, and the amplitude sum of the second detection signal and the third detection signal to generate said corresponding subtraction signal.

10. The optical detection system of claim 8, wherein the predetermined signal subtraction procedure gets the difference between the sum of phases of the second detection signal and the fourth detection signal, and the sum of phases of the first detection signal and third detection signal to generate said corresponding subtraction signal.

11. The optical detection system of claim 10, wherein the second detection signal and the fourth detection signal are in-phase signals and the first detection signal and the third detecting signal are in-phase signals, and the corresponding subtraction signal is a differential phase detection (DPD) signal.

12. The optical detection system of claim 5, wherein the optical detection system further comprise:
a high threshold comparator for comparing the band pass filtered signal with a predetermined high threshold reference signal to generate a high threshold compared signal; and
a low threshold comparator for comparing the band pass filtered signal with a predetermined low threshold reference signal to generate a low threshold compared signal;
wherein the optical detection system can determine that the reflective light beam detected by pickup head comes from the land storage track or the groove storage track according to the high threshold compared signal and the low threshold compared signal.

13. The optical detection system of claim 5, wherein the band pass filter further comprises:
a low pass filter for filtering off the high frequency of the subtraction signal to generate a low pass filtered signal; and
a high pass filter for filtering off the low frequency of the low pass filtered signal to generate a band pass filtered signal.

14. The optical detection system of claim 13, wherein the low pass filtered signal is a kind of step signal, and the band pass filtered signal is a kind of pulse signal.

15-18. (canceled)

19. An optical detection method for detecting various storage tracks of an optical storage medium, said optical storage medium comprising at least one land storage track and at least one groove storage track, each storage track being divided into a central region and two edge regions, and each sector further comprising a data area to record a digital data and a header to record an address data, the digital data comprising a plurality of bits data and being stored in the central region of the data area along the direction of the storage track, the address data also comprising a plurality of bits data and being stored in the edge region of the header along the direction of the storage track, the data storage sequence of the address data stored in the edge region of the header being different from said land storage area and said groove storage area, the optical direction method comprising following steps:
providing an incident light beam to said data area and said header, and modulated by the plurality of bits to generate said corresponding reflective light beam;
providing a pickup head, disposed in a predetermined distance away from said optical storage medium, for substantially locking on the central region of the sector, and detecting a reflective light beam along the direction of the storage track, said pickup head comprising:
a left-side detection module, disposed in the left side of said pickup head along the direction of said storage track, for detecting said reflective light beam to generate a disposed of left-side detection signals correspondingly; and
a right-side detection module, disposed in the right side of said pickup head along the direction of said storage track, for detecting said reflective light beam to generate a disposed of right-side detection signals correspondingly;
getting the difference between the disposed of the left-side detection signals and the set of the right-side detection signals detected by the pickup head by means of a predetermined signal subtraction procedure to generate corresponding subtraction signal; and
wherein the optical detection method can determine that the reflective light beam detected by said pickup head comes from the land storage track or the groove storage track according to the band pass filtered signal.

20. The optical detection method of claim 19, wherein the predetermined signal subtraction procedure gets the difference between the amplitude of the left-side detecting signal and the amplitude of the right-side detection signal detected by the pickup head to generate a corresponding subtraction signal.
